(19) United States
(12) Patent Application Publication
(10) Pub. No.: US 2017/0203797 A1
(43) Pub. Date: Jul. 20, 2017

(54) INTERIOR MATERIAL FOR AUTOMOBILE

(71) Applicant: Kotobukiya Fronte Co., Ltd., Tokyo (JP)

(72) Inventor: Tetsuya Masumura, Saitama (JP)

(21) Appl. No.: 14/996,475

(22) Filed: Jan. 15, 2016

(51) Int. Cl. B62D 29/04; B32B 3/26

(52) U.S. Cl. CPC B62D 29/04; B32B 3/266; B32B 2307/102; B32B 2605/003

(57) ABSTRACT

[Problem to be Solved] The present invention provides an interior material for an automobile that can secure appropriate sound absorption properties in a noise frequency band of 630 to 2500 Hz.

[Solution] An interior material 1 for an automobile according to the present invention includes a laminate 4 made up of a surface layer 2 facing the interior and a ventilation control layer 3 provided with holes, and a cushion layer 5 on the vehicle body side pasted to the laminate 4, wherein the proportion of open hole area in the ventilation control layer 3 is set such that a flow resistance value of the laminate 4 will be at least 1000 Ns/m³ but less than 6000 Ns/m³. The interior material is configured to reliably absorb any noise infiltrating a vehicle. Also, the interior material may include a cushion layer pasted to the laminate 4 via an intermediate sound absorption layer 6 and a sound insulation layer 7, so that noise entering the vehicle from tires through the underside of an automobile can be reduced.

### BACKGROUND OF THE INVENTION

Field of the Invention

The present invention relates to an interior material for an automobile.

Description of the Related Art

Generally, as shown in FIG. 7, an automobile (tires not shown) includes an engine room 61 in front, a trunk room 62 in rear, and a passenger compartment 63 there between. In the passenger compartment 63, there are front seats 64 and rear seats 64′, and a floor carpet 66 is laid on a floor (steel panel) 65. Also, a dash insulator 67 is installed on the side of the engine room 61, and a trunk trim 68 is installed in the trunk room 62. The floor carpet 66, dash insulator 67, and trunk trim 68 are mainly made of fibrous materials to absorb noise. The floor carpet 65, in particular, is made of a material with superior sound insulation and sound absorption properties. Types of automotive noise include various sounds coming from the outside of the vehicle through windows, sounds produced by tires in contact with the road, and sounds produced by the engine. Loud noises occur in a frequency band of 630 to 2500 Hz, making it necessary to control noise in this frequency band.

The floor carpet varies in shape depending on the type of vehicle, but being depressed at the passenger's feet position of the front seats 64 and rear seats 64′ in the passenger compartment 63 from the standpoint of comfort, the floor carpet generally has a concavo-convex pattern. Moreover, the portion of the floor carpet that comes under the passengers' feet is increased in thickness. Besides, the floor carpet has been produced by laminating a surface layer facing the interior and a ventilation control layer having open holes and by pasting a cushion layer to the laminate. When produced, the floor carpet is heated, drawn through a forming die, and finished into a concavo-convex shape using a forming die for particular vehicle type. Then it is completed by undergoing a trimming process.

A number of patent documents exist in relation to the floor carpet. One of the patent documents is JP 05-504528 A. Heavy materials with a thickness of 2 mm and a diameter of holes 9 mm were previously used for the ventilation control layer, but a light material (plastic film) with a thickness of around 0.8 mm has come to be made recently. When the diameter of holes is 9 mm or larger, however, heat will concentrate on the holes during heating, locally burning the surface layer (design layer) and creating a spot pattern, impairing visual appearance. Also, if the pitch of holes is reduced, there is a problem in that the ventilation control layer tears easily along holes during the drawing process.

The second patent document is JP 2005-001403 A. In this case, the proportion of open area of holes in the ventilation control layer is set such that the flow resistance value will be less than 1000 Ns/m³. With such a flow resistance value, appropriate sound absorption properties cannot be secured in the noise frequency band of 630 to 2500 Hz. Also, with recent development of fuel-efficient vehicles such as electric vehicles and hybrid vehicles, weight reduction of the floor carpet has become important, but sound absorption performance in the noise frequency band of 630 to 2500 Hz has not been improved.

The third patent document is JP 2002-219989 A. In this case, the floor carpet is formed by spraying 250 g/m² or more of thermoplastic resin powder on the ventilation control layer. As a result of experiments, however, when an average of flow resistance values is in a range of 3000 to 6000 Ns/m³, the value for standard deviations, which represents dispersion, becomes as large as 2000 to 5000 Ns/m³ and heating could become uneven in a heating step for the carpet, spoiling the appearance.

However, the floor carpet disclosed in JP 05-504528 A has problems with the ventilation control layer, and the floor carpet disclosed in JP 2005-1403 A does not have good sound absorption performance at the noise frequency band of 630 to 2500 Hz. Furthermore, according to JP 2002-219989 A, the flow resistance value remains unstable as thermoplastic resin powder is used.

### SUMMARY OF THE INVENTION

In view of the above problems, the present invention has an object to provide such an interior material for an automobile that can secure appropriate sound absorption properties at a noise frequency band of 630 to 2500 Hz.

To achieve the above object, the present invention provides an interior material for an automobile, comprising: a laminate made up of a surface layer facing the interior and a ventilation control layer provided with holes; and a cushion layer pasted to the laminate, wherein a proportion of open hole area in the ventilation control layer is set such that a flow resistance value of the laminate is at least 1000 Ns/m³ but less than 6000 Ns/m³. The interior material is configured to reliably absorb noise which may come into a vehicle.

Also, according to a second aspect, in the interior material for an automobile, the surface layer is made up of a design layer and a sound absorption layer. The interior material is configured such that even if a design layer and a sound absorption layer are provided in locations, like floor carpet and trunk trim installed on a floor of a passenger compartment, which come to people's notice or where it is desirable to absorb noise, a design layer may not have to be provided in locations, like dash insulator, which do not come to people's notice or where noise absorption is not important.

Furthermore, according to a third aspect, in the interior material for an automobile, the thickest portion of the laminate has a peak of sound absorption properties at a frequency band of 630 to 2500 Hz. The interior material is configured such that noise in this frequency band can be absorbed reliably by the thickest portion of the laminate.

Furthermore, according to a fourth aspect, in the interior material for an automobile, the pitch of holes in the ventilation control layer is 10 to 50 mm, such that heat does not concentrate on a single hole during the heating step and that design of the surface layer is not spoiled.

Furthermore, according to a fifth aspect, in the interior material for an automobile, the cushion layer is pasted to the laminate via an intermediate sound absorption layer and a sound insulation layer, so that the interior material can reliably reduce noise entering the vehicle from tires.

Since the proportion of open area of holes in the ventilation control layer is set such that the flow resistance value of the laminate will be between 1000 Ns/m³ and 6000 Ns/m³, even if noise comes into the vehicle, such noise can advantageously be reduced with reliability through the laminate.

Also, according to the second aspect of the present invention, the design layer and sound absorption layer are provided in locations, like the floor carpet and trunk trim installed on the floor of the passenger compartment, which come to people's notice or where it is desirable to absorb noise, without having a design layer in locations, like the dash insulator, which do not usually come to people's notice, so as to advantageously achieve cost reductions and realize lower prices.

Furthermore, according to the third aspect of the present invention, since the proportion of open area of holes in the ventilation control layer is set such that the flow resistance value of the laminate will be between 1000 Ns/m³ and 6000 Ns/m³, noise can be reduced at the frequency band of 630 to 2500 Hz by the thickest portion of the laminate.

Furthermore, according to the fourth aspect of the present invention, the noise can be advantageously reduced at the frequency band of 630 to 2500 Hz at which band such automotive noise as noise entering through windows, noise produced by tires in contact with the road surface, and noise produced by the engine is high, and the surface layer can be prevented from being spoiled because heat does not concentrate on a single hole during the heating step.

Moreover, according to the fifth aspect of the prevent invention, since the cushion layer on the vehicle body side is equipped with the sound absorption layer and sound insulation layer, noise entering from the cushion layer side can be reduced.

### DETAILED DESCRIPTION OF THE PREFERRED EMBODIMENTS

Next, embodiments of the present invention will be described with reference to the drawings. FIG. 1 is an enlarged sectional view of an interior material according to the present invention; FIG. 2 is a plan view of a ventilation control layer; FIGS. 3A and 3B show punching tools, where FIG. 3A is a twin-blade punching die and FIG. 3B is a punch needle; FIG. 4 is a line graph showing sound absorption performance of samples 1 to 4; FIG. 5 is an enlarged sectional view showing a case in which a sound absorption layer and sound insulation layer are provided in the cushion layer; FIG. 6 is a line graph showing sound absorption performance of samples 5 to 7; and FIG. 7 is a sectional view showing arrangement of a typical interior material of an automobile.

The interior material 1 according to the present invention is used as floor carpet 66, dash insulator 67, and trunk trim 68 in automobiles. As shown in FIG. 1, the interior material 1 includes a laminate 4 and a cushion layer 5, where the laminate 4 is made up of a surface layer 2 and a ventilation control layer 3 having holes 31 laminated in order from the top, and the cushion layer 5 is pasted to the undersurface of the laminate 4. In the surface layer 2, a design layer 2a and a sound absorption layer 2b are used for the floor carpet 66 and trunk trim 68, which come to people's notice and desirably absorb noise, being laid on the floor 65 of the passenger compartment, but the dash insulator 67, which rarely come to people's notice, may mainly be made up of a fibrous material without using a design layer 2a. The cushion layer 5, which is designed to absorb vibrations from the vehicle body, may be installed on the undersurface of the laminate 4 via an intermediate sound absorption layer 6 and a sound insulation layer 7.

The design layer 2a used for the surface layer 2 is made up of a tufted carpet layer or a needle punched layer, and has an apparent surface density of 150 to 600 g/m². Also, the sound absorption layer 2b is installed to improve sound absorption performance and is made of a PET (polyethylene terephthalate) material or a cotton material. It has an apparent surface density of 200 to 1000 g/m².

Materials available for the ventilation control layer 3 include thermoplastic resin films of PET, ABS, polyamide, polyethylene, polypropylene, and the like. The cushion layer 5 partially varies in thickness within a range of 2 to 50 mm depending on the shape of the vehicle body. Available materials include PET, cotton, and urethane foam.

The ventilation control layer 3 is made of a film having a thickness in the range of 0.01 to 0.30 mm, and provided with a large number of holes 31 as shown in FIG. 2 to ensure air permeability. The shape of the holes 31 is not of particular concern, and may be circular or oval, but the diameter R of the holes 31 is preferably in a range of 0.5 to 8 mm. Also, the holes 31 are arranged in substantially a grid pattern (or in a staggered pattern) with hole pitches K and K′ of 10 to 50 mm. Regarding the method for machining the holes 31, a twin-blade punching die 32 having an upper blade 32a and lower blade 32b on opposite sides of the film as shown in FIG. 3A is preferable because sharp holes with reduced burrs can be produced. On the other hand, if the film is pierced from above with a punch needle 33 as shown in FIG. 3B, the film may have burrs and lack sharpness.

The floor carpet 66 was produced experimentally, and when the diameter R of the holes 31 was set to be larger than 8 mm (9 mm or larger), a problematic situation became apparent: a spot pattern was produced on the surface layer 2 as a result of heat concentration during heat treatment in an open heating furnace during the carpet production process. When the pitches K and K′ of the holes 31 are less than 10 mm, the ventilation tends to be disturbed and when the hole pitches K and K′ exceed 50 mm, spacing between adjacent holes becomes too wide, which might result in a large difference between a ventilating portion and resisting portion. Besides, the flow resistance value is affected by the proportion of open area of the holes 31 (including the hole pitches and hole diameter).

To test the sound absorption performance of the interior material 1 according to the present invention, the cushion layer 5 with a polyethylene adhesive applied to both sides was laminated (integrated) between the design layer 2a of the surface layer 2 and the cushion layer 5, where the design layer 2a had an apparent surface density of 250 g/m² and the cushion layer 5 had a thickness of 10 mm and an apparent surface density of 1100 g/m². The sound absorption layer 2b was not used here. The laminate 4 was 12 mm thick. The pitches K and K′ of the holes 31 in the ventilation control layer 3 were 20 mm, samples 1 to 4 below were prepared by varying the proportion of open hole area, and the sound absorption performance of each sample was measured in terms of a normal incidence sound absorption coefficient (in compliance with ISO 10534-2).

Sample 1: the proportion of open hole area in the ventilation control layer 3 was 1.8% and the flow resistance value was 4000 Ns/m³ (following ISO 9053). Sample 2: the proportion of open hole area in the ventilation control layer 3 was 2% and the flow resistance value was 2600 Ns/m³. Sample 3: the proportion of open hole area in the ventilation control layer 3 was 3% and the flow resistance value was 1800 Ns/m³. Sample 4: the proportion of open hole area in the ventilation control layer 3 was 7% and the flow resistance value was 500 Ns/m³. Here, the “flow resistance values” were mainly attributable to the design layer 2a to the ventilation control layer 3 in the laminate 4.

As a result of the sound absorption performance measurement, a line graph was created as shown in FIG. 4. As can be seen from the graph, in the case of sample 3 with a flow resistance value of 1800 Ns/m³, the sound absorption performance peaked at 2500 Hz; in the case of sample 2 with a flow resistance value of 2600 Ns/m³, the sound absorption performance peaked at 2000 Hz; and in the case of sample 1 with a flow resistance value of 4000 Ns/m³, the sound absorption performance peaked at 1600 Hz. In these examples, when the proportion of open hole area in the ventilation control layer 3 is 3%, if the flow resistance value is kept at 1500 Ns/m³ or above, the sound absorption performance can have a peak in the frequency band of 630 of 2500 Hz.

In particular, as with sample 2, when the proportion of open hole area in the ventilation control layer 3 is 2% and the flow resistance value is kept at 2600 Ns/m³ or above, the sound absorption performance can have a peak in the frequency band of 630 of 2000 Hz, resulting in further performance improvement.

As shown in FIG. 5, the interior material 1 according to the present invention includes the laminate 4 made up of the design layer 2a, the sound absorption layer 2b, and ventilation control layer 3 provided with the holes 31 as well as the cushion layer 5 pasted to the undersurface of the laminate 4 via the intermediate sound absorption layer 6 and sound insulation layer 7. Naturally, the design layer 2a and sound absorption layer 2b are needed in locations, such as the floor carpet and trunk trim 68 installed on the floor of the passenger compartment, which come to people's notice or where it is desired to absorb noise, and needless to say the design layer 2a may not be used in locations, such as the dash insulator 67, which do not come to people's notice.

In the interior material 1 according to the present invention shown in FIG. 5, the design layer 2a is made up of a tufted carpet layer or needle punch layer, and has an apparent surface density of 150 to 600 g/m². The sound absorption layer 2b is, installed to improve sound absorption performance, is made of PET material or cotton material, and has an apparent surface density of 200 to 1000 g/m². Materials available for the ventilation control layer 3 include thermoplastic resin films of PET, ABS, polyamide, polyethylene, polypropylene, and the like. The holes 31 are also provided. The proportion of open area of the holes 31 (including the hole pitches and hole diameter) affects the flow resistance value. The cushion layer 5 partially varies in thickness within a range of 2 to 50 mm depending on the shape of the vehicle body. Available materials include PET material, cotton material, and urethane foam.

The intermediate sound absorption layer 6, which is installed to improve sound absorption effect on the interior side, is made of PET material or cotton material and has an apparent surface density of 300 to 1500 g/m². The sound insulation layer 7 is made of heavy tabular material and plays a role of shutting out noise entering from under the automobile body. The thickness is set at 1 to 3 mm and the surface density is set at 0.8 to 4 kg/m². The cushion layer 5 is partially varied in thickness from 2 to 40 mm depending on the shape of the vehicle body to improve fit to the vehicle body because the thickness of the floor carpet varies with the shape of the vehicle body. Available materials include PET material, cotton material, and urethane foam.

The sound absorption performance of the interior material 1 according to the present invention equipped with the intermediate sound absorption layer 6 and sound insulation layer 7 is shown in FIG. 6. The design layer 2a has an apparent surface density of 400 g/m² and is joined to the sound absorption layer 2b. The ventilation control layer 3 is made up of a 0.03-mm-thick film sheet with a polyethylene adhesive applied to both sides and is adhesively fixed between the sound absorption layer 2b and intermediate sound absorption layer 6. The apparent surface density of the intermediate sound absorption layer 6 is 400 g/m². Here, the thickness of the laminate from the design layer 2a to the intermediate sound absorption layer 6 was set to 10 mm, the thickness of the heavy sound insulation layer 7 was set to 2 mm, and the surface density was set to 2.8 kg/m². The thickness of the cushion layer 5 was 10 mm, the apparent surface density of the cushion layer 5 was 550 g/m², and the overall thickness of the interior material 1 was 22 mm. The pitches K and K′ of the holes 31 in the ventilation control layer 3 were 20 mm, samples 5 to 7 below were prepared by varying the proportion of open hole area, and the sound absorption performance of each sample was measured in terms of normal incidence sound absorption coefficient (in compliance with ISO 10534-2).

Sample 5: the proportion of open hole area in the ventilation control layer 3 was 2% and the flow resistance value was 3000 Ns/m³ (ISO 9053 standard). Sample 6: the proportion of open hole, area of the ventilation control layer 3 was 3% and the flow resistance value was 1500 Ns/m³. Sample 7: the proportion of open hole area of the ventilation control layer 3 was 7% and the flow resistance value was 300 Ns/m³. Here, the “flow resistance values” were mainly attributable to the laminate 4 ranging from the design layer 2a to the ventilation control layer 3 (including the sound absorption layer 2b).

As a result of the sound absorption performance measurement, a line chart was created as shown in FIG. 6. In the case of sample 6, in which the proportion of open hole area in the ventilation control layer 3 was 3% and the flow resistance value was 1500 Ns/m³ or higher, the sound absorption performance had a peak in the frequency band of 630 of 2500 Hz. In the case of sample 5, in which the proportion of open hole area in the ventilation control layer 3 was 2% and the flow resistance value was 3000 Ns/m³, the sound absorption performance peaked at around 1000 Hz in the frequency band, which meant that the sound absorption performance had a peak in the frequency band of 630 of 2000 Hz, enabling further performance improvement.

With the interior material 1 according to the present invention the sound absorption performance can be in the best condition in the noise frequency band of 630 to 2500 Hz without spoiling design during the heating step for production. The present invention is useful, for example, as an interior material such as floor carpet, dash insulator, and trunk trim for automobiles, and has highly broad industrial applicability.

### BRIEF DESCRIPTION OF THE DRAWINGS

FIG. 1 is an enlarged sectional view of an interior material according to the present invention;

FIG. 2 is a plan view of the ventilation control layer;

FIGS. 3A and 3B show punching tools, where FIG. 3A is a twin-blade punching die and FIG. 3B is a punch needle;

FIG. 4 is a line graph showing the sound absorption performance of samples 1 to 4;

FIG. 5 is an enlarged sectional view showing a case in which an intermediate sound absorption layer and sound insulation layer of a cushion layer are provided;

FIG. 6 is a line graph showing the sound absorption performance of samples 5 to 7-; and

FIG. 7 is a sectional view showing arrangement of a typical interior material of an automobile.

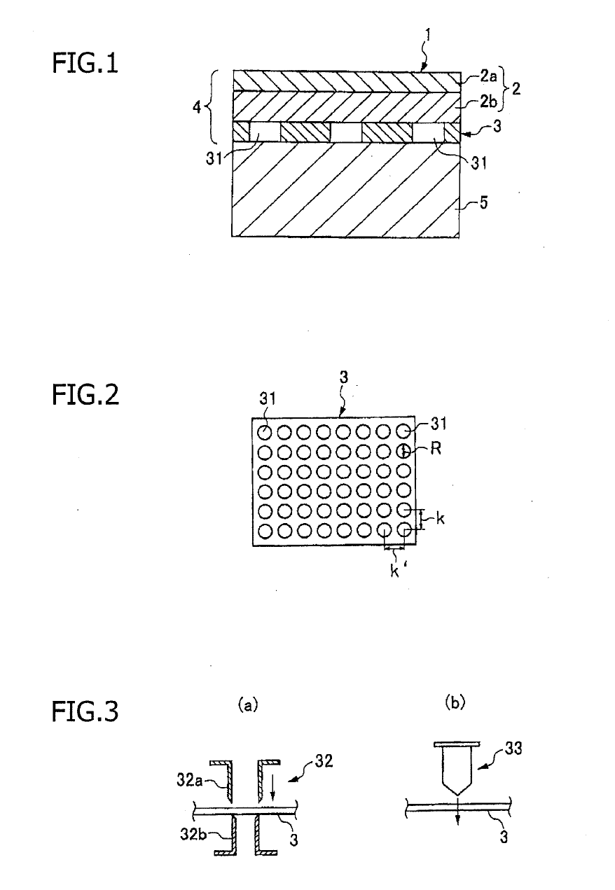

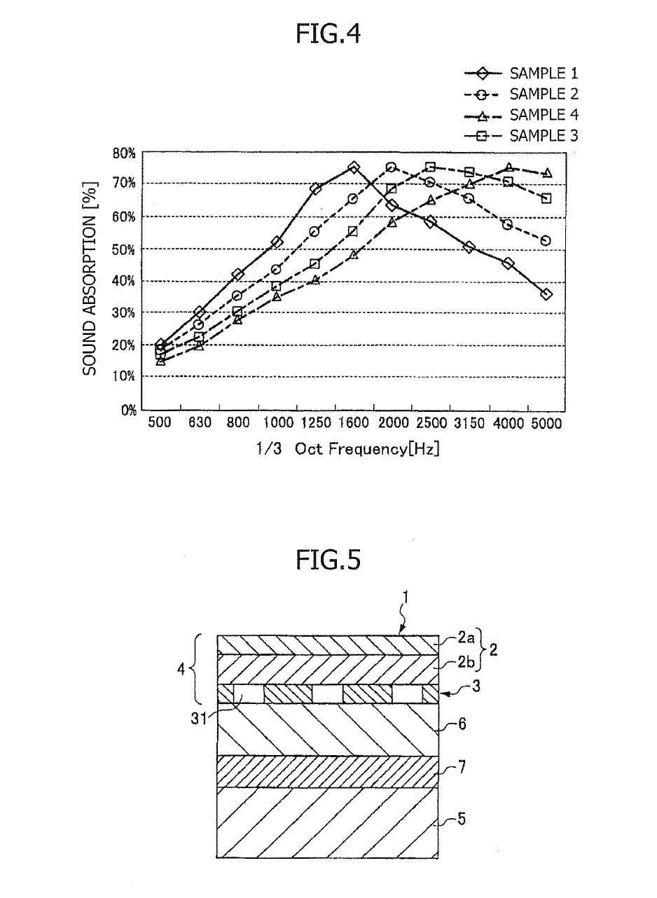

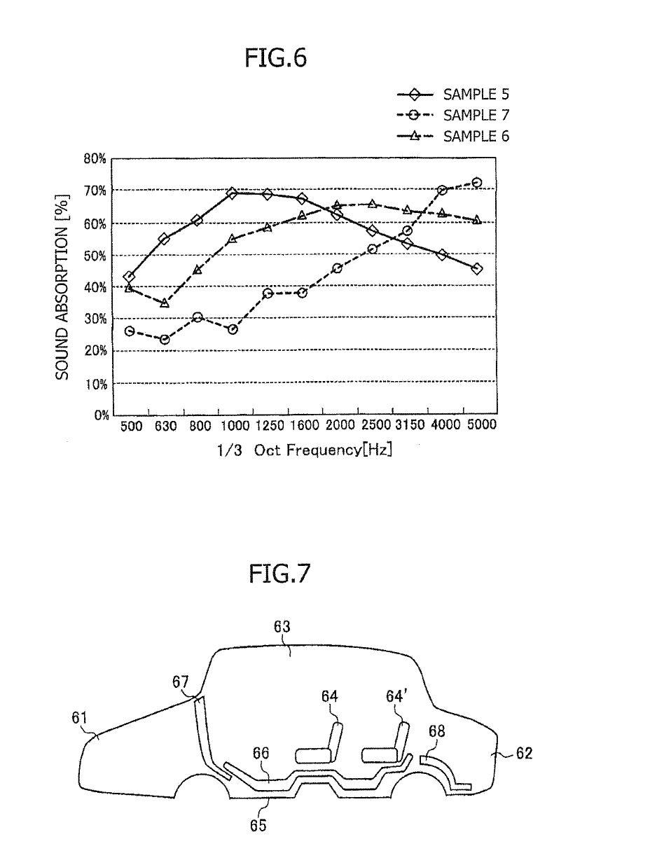

### REFERENCE SIGNS LIST

1 Interior material according to the present invention
2 Surface layer
2a Design layer
2b Sound absorption layer
3 Ventilation control layer
31 Hole
32 Punching die
32a Upper blade
32b Lower blade
33 Punch needle
R Hole diameter
K, K′ Hole pitch
4 Laminate
5 Cushion layer
6 Intermediate sound absorption layer
7 Insulation layer
66 Floor carpet
67 Dash insulator
68 Trunk trim

1. An interior material for an automobile, comprising: a laminate made up of a surface layer facing the interior and a ventilation control layer provided with holes; and a cushion layer pasted to the laminate, wherein a proportion of open hole area in the ventilation control layer is set such that a flow resistance value of the laminate is between 1000 Ns/m³ and 6000 Ns/m³, wherein the ventilation control layer has a thickness of 0.01 to 0.30 mm, the holes are arranged in a grid pattern with a hole pitch of 10 to 50 mm, and the holes are 0.5 to 8 mm in diameter.

2. The interior material for an automobile according to claim 1, wherein the surface layer is made up of a design layer and a sound absorption layer.

3. The interior material for an automobile according to claim 1, wherein the thickest portion of the laminate has a peak of sound absorption properties in a frequency band of 630 to 2500 Hz.

4. The interior material for an automobile according to claim 1, wherein a hole pitch in the ventilation control layer is 10 to 50 mm.

5. (canceled)

6. The interior material for an automobile according to claim 1, wherein the interior material has an overall thickness of 4 mm or larger.

7. The interior material for an automobile according to claim 1, wherein the cushion layer is pasted to the laminate via an intermediate sound absorption layer and a sound insulation layer.

8.-9. (canceled)

10. The interior material for an automobile according to claim 1, wherein an intermediate sound absorption layer is laminated between the cushion layer and the ventilation control layer.

11. The interior material for an automobile according to claim 1, wherein a sound insulation layer is laminated between the cushion layer and the ventilation control layer.
